(19) United States
(12) Patent Application Publication
(10) Pub. No.: US 2015/0334000 A1
(43) Pub. Date: Nov. 19, 2015

(54) BORDER GATEWAY PROTOCOL (BGP) ROUTES ADVERTISEMENT

(71) Applicant: HANGZHOU H3C TECHNOLOGIES CO., LTD., Hangzhou, Zhejiang (CN)

(72) Inventors: Haifeng ZHANG, Beijing (CN); Yifan ZHOU, Beijing (CN)

(73) Assignee: Hangzhou H3C Technologies Co., Ltd., Hangzhou City (CN)

(21) Appl. No.: 14/648,149

(22) PCT Filed: Jan. 10, 2014
(86) PCT No.: PCT/CN2014/070441

§ 371 Date: May 28, 2015

(30) Foreign Application Priority Data
Jan. 21, 2013 (CN) 201310022770.1

(51) Int. Cl. H04L 12/751; H04L 12/707

(52) U.S. Cl. CPC H04L 45/02; H04L 45/22

(57) ABSTRACT

When updated routing information is advertised, attributes of the updated routing information are advertised in a first UPDATE message and prefixes of the updated routing information are advertised in a second UPDATE message.

### BACKGROUND

Border Gateway Protocol (BGP) is a dynamic routing protocol deployed among autonomous systems (ASs).

According to RFC 4271, there are five kinds of BGP messages: OPEN message, KEEPLIVE message, UPDATE message, NOTIFICATION message, and ROUTE-REFRESH message.

The UPDATE message is used for advertising routing information between peer nodes. Besides a 19-octet header, the UPDATE message further includes an unfeasible routes length (URL) field, a withdrawn routes (WR) field, a path attribute length (PAL) field, a path attribute (PA) field, and a network layer reachability information (NLRI) field. One UPDATE message may advertise a group of feasible routes with identical path attributes. Prefixes of these feasible routes are put in the NLRI field, and the attributes of these routes are put in the PA field. BGP selects routes according to the attributes. Or, the UPDATE message may carry multiple unfeasible routes. The unfeasible routes which are withdrawn from service are put in the WR field.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating BGP route advertisement using UPDATE message during a routing information update procedure according to an example of the present disclosure.

FIG. 2 is a schematic diagram illustrating BGP route advertisement using UPDATE message during a routing information withdrawn procedure according to an example of the present disclosure.

FIG. 3 is a flowchart illustrating a method of BGP route advertisement at a transmitting end during a routing information update procedure according to an example of the present disclosure.

FIG. 4 is a flowchart illustrating a method of BGP route advertisement at a receiving end during a routing information update procedure according to an example of the present disclosure.

FIG. 5 is a flowchart illustrating a method of BGP route advertisement at a transmitting end during a routing information withdrawn procedure according to an example of the present disclosure.

FIG. 6 is a flowchart illustrating a method of BGP route advertisement at a receiving end during a routing information withdrawn procedure according to an example of the present disclosure.

FIG. 7A is a schematic diagram illustrating a structure of BGP route advertising apparatus according to an example of the present disclosure.

FIG. 7B is a schematic diagram illustrating a structure of a BGP route advertising apparatus according to another example of the present disclosure.

FIG. 8 is a schematic diagram illustrating a structure of a BGP route advertising apparatus according to still another example of the present disclosure.

FIG. 9A is a schematic diagram illustrating a structure of a BGP route maintaining apparatus according to an example of the present disclosure.

FIG. 9B is a schematic diagram illustrating a structure of a BGP route maintaining apparatus according to another example of the present disclosure.

FIG. 10 is a schematic diagram illustrating a structure of a BGP route maintaining apparatus according to still another example of the present disclosure.

FIG. 11 is a schematic diagram illustrating a structure of a BGP route maintaining apparatus according to yet another example of the present disclosure.

FIG. 12 is a schematic diagram illustrating hardware and machine readable instructions in a BGP route advertising apparatus 1200 according to an example of the present disclosure.

FIG. 13 is a schematic diagram illustrating hardware and machine readable instructions in a BGP route maintaining apparatus 1300 according to an example of the present disclosure.

### DETAILED DESCRIPTION

Hereinafter, the present disclosure is described in further detail with reference to the accompanying drawings and examples.

When there is updated routing information (e.g., there is a new route or a replacement route) to be advertised to peer nodes, a BGP speaker acting as a transmitting end transmits an UPDATE message carrying attributes and prefixes for the updated routing information to the peer nodes acting as receiving ends. In a conventional UPDATE message used for advertising the updated routing information, both the prefixes and the attributes of the routing information are carried. For example, the prefixes of the routing information may be put in the NLRI field of the UPDATE message, and the attributes corresponding to the prefixes of the routing information may be put in the PA field of the UPDATE message.

The length of the UPDATE message is limited (maximum 4096 octets). If the attributes occupy too many octets of the UPDATE message, the number of prefixes that one UPDATE message can carry is reduced. As such, more UPDATE messages are used to advertise the routing information.

For example, for prefixes of routes with 24-bit mask code, each prefix occupies 4 octets of the UPDATE message. If the attributes occupy 100 octets of the UPDATE message, one UPDATE message is able to carry about 1000 prefixes at most. Accordingly, the routing information including 1000 prefixes may be advertised by merely one UPDATE message. If the attributes occupy 4000 octets of the UPDATE message, one UPDATE message is able to carry about 20 prefixes at most. Thus, the routing information including 1000 prefixes may need a large number of UPDATE messages to be advertised, for instance, in the above example it may need almost 50 UPDATE messages.

With the development of network techniques, it is the trend that the attributes of the BGP routing information become increasingly complex. Thus, the attributes occupy more and more octets of the UPDATE message, and the number of UPDATE messages used for advertising routing information increases.

In an example of the present disclosure, when there is updated routing information to be advertised, a transmitting end advertises attributes of the routing information separately, and an identifier attribute used for identifying the attributes is advertised along with the attributes. The attributes which should have been advertised along with the prefixes are replaced by the identifier attribute which is shorter in length.

Therefore, the attributes and the prefixes are advertised via different UPDATE messages. An identifier attribute is carried in the UPDATE message to ensure an association relationship between the attributes and the prefixes for route maintenance at the receiving end.

As such, the prefixes occupy the length of the UPDATE message by themselves. The number of prefixes that an UPDATE message can carry is increased. Therefore, the number of UPDATE messages for advertising the updated routing information is reduced. Efficiency for advertising the updated routing information is increased and the load for parsing the UPDATE messages is also reduced at the receiving end.

For example, for prefixes of routes with 24-bit mask code, each prefix occupies 4 octets of the UPDATE message. The prefixes and the attributes are not advertised in the same UPDATE message. Compared with the maximum length 4096 octets of the UPDATE message, the length of the identifier attribute which is carried in the same UPDATE message with the prefixes may be omitted. Therefore, the UPDATE message used for advertising prefixes may carry about 1000 prefixes. Accordingly, the routing information including 1000 prefixes may be advertised by merely two UPDATE messages, one UPDATE message is used for advertising the attributes, and the other UPDATE message is used for advertising 1000 prefixes.

In view of the above, compared with the conventional technique, the example of the present disclosure may be able to reduce the number of the UPDATE messages in the case that a large number of prefixes is to be advertised and the prefixes are relatively long.

As to the separate advertising of the attributes and the prefixes, the receiving end respectively maintains the attributes and the prefixes and associates them using the identifier attribute. Therefore, in order to be compatible with the separate maintenance of the attributes and the prefixes at the receiving end, when the transmitting end advertises routing information that is being withdrawn from service, the attributes and the prefixes of the routing information being withdrawn from service are advertised separately. Compared with conventional technique, an example of the present disclosure adds a new UPDATE message for advertising the attributes of the routing information being withdrawn from service. Compared with the number of UPDATE messages reduced by the example, the number of the newly-added UPDATE message is negligible.

Hereinafter, the implementation of the present disclosure is described with reference to some examples.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

In an example, a BGP capability set is extended and an Attr-Adv Cap (Attribute Advertise Capability) identifier is added to the capability set so as to identify that a peer node supports “attribute separate advertising.” The length of the capability identifier may be 1 octet. Accordingly, a peer node configured with an Attr-Adv Cap identifier has an Attr-Adv feature of attribute separate advertising, i.e., the peer node can implement the route advertisement according to the example of the present disclosure.

In a practical application, in order to be compatible with the conventional technique, it is possible to configure only some peer nodes to have the Attr-Adv feature. In this situation, if the route advertisement between peer nodes is to be implemented by way of the examples of the present disclosure, two sides of the advertisement may negotiate capabilities via OPEN messages so as to determine whether a peer node supports attribute separate advertising.

If any one of the two sides supports attribute separate advertising, an OPEN message transmitted by this peer node carries the Attr-Adv Cap identifier. Accordingly, after receiving the OPEN message carrying the Attr-Adv Cap identifier from a peer node, it is determined that the peer node supports attribute separate advertising. Otherwise, it is determined that the peer node does not support attribute separate advertising.

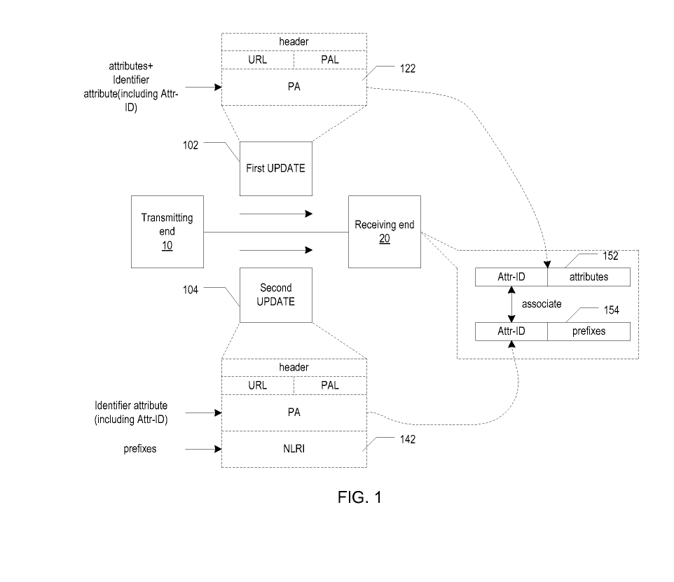

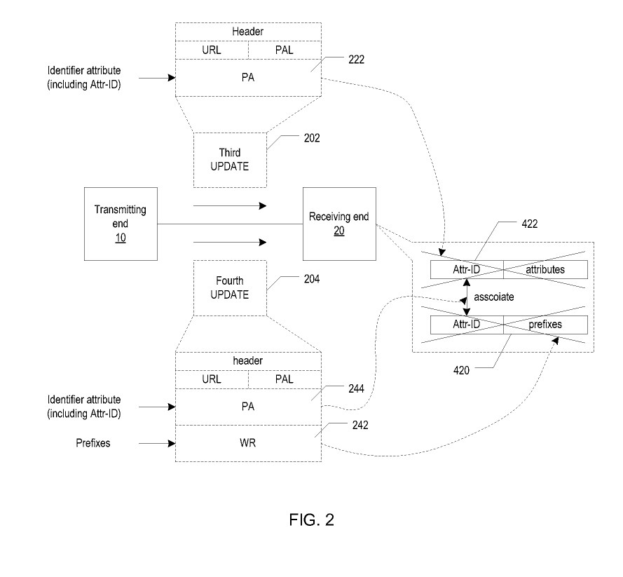

After the above negotiation procedure, if both sides support the attribute separate advertising, routes can be advertised among peer nodes as shown in FIG. 1 and FIG. 2. If any one of the two sides does not support the attribute separate advertising, the negotiation fails. At this time, the routes have to be advertised according to a conventional technique.

In addition, an example of the present disclosure extends an attribute set and adds the above identifier attribute in the attribute set. Each attribute which previously exist in the attribute set includes detailed attribute information and is attached to prefixes. Different from the existing attributes in the attribute set, the identifier attribute does not include any attribute information but the identifier attribute includes an Attr-ID (Attribute Identity) used for identifying an attribute. The identifier attribute is not attached to prefixes but it is used for associating the prefixes and the attached attributes through identifying the attributes.

During an implementation, the identifier attribute may be configured according to an attribute format defined by a protocol, i.e., including an attribute type field, a flag field, and an attribute content field.

The attribute type may be configured to a value indicating that this attribute is used for identifying attributes. For situations that the identified attributes are to be updated or withdrawn, the value of the attribute type may be different. For example, if the identified attributes are to be updated, the value of the attribute type is configured to 0xff. If the identified attributes are to be withdrawn, the value of the attribute type is 0xfe. In a practical application, prefixes are usually put in the NLRI field during an update procedure and are put in the WR field during a withdrawal procedure. Instead of differentiating update and withdrawal procedures by the attribute type, the two situations may be differentiated by the fields that the prefixes are put in.

The flag may be configured to a value, e.g., 0x40, indicating that the receiving end is to recognize the identifier attribute. In other words, only a receiving end configured with the Attr-Adv feature can recognize this identifier attribute. Therefore, only the receiving end configured with the Attr-Adv feature can perform a corresponding operation according to the identifier attribute.

The length of the attribute content may be configured to 4 octets, including an Attr-ID used for identifying the attributes.

In addition, the UPDATE message is to realize four kinds of advertising functions in the example of the present disclosure: attribute advertisement during routing information update, prefix advertisement during routing information update, attribute advertisement during routing information withdrawal, and prefix advertisement during routing information withdrawal. For these four functions, the format of the UPDATE message is to be modified accordingly.

For the UPDATE message implementing the attribute advertisement during the routing information update (referred to as first UPDATE message hereinafter for facilitating the description), attributes and an identifier attribute are put in the PA field, and a total length of the attributes and the identifier attribute is put in the PAL field. The NLRI field may not be required. In addition, the WR field may also not be required and the URL field may be filled with 0.

For the UPDATE message implementing the prefix advertisement during the routing information update (referred to as second UPDATE message hereinafter for facilitating the description), an identifier attribute is carried in the PA field. A length (e.g., 4 octets) of the identifier attribute is put in the PAL field. The prefixes are put in the NLRI field. The WR field may not be required and the URL field may be filled with 0.

For the UPDATE message implementing the attribute advertisement during the routing information withdrawal (referred to as third UPDATE message hereinafter for facilitating the description), the identifier attribute is put in the PA field and a length (e.g., 4 octets) of the identifier attribute is put in the PAL field. The NLRI field may not be required. In addition, the WR field may not be required and the URL field may be filled with 0.

For the UPDATE message implementing the prefix advertisement during the routing information withdrawal (referred to as fourth UPDATE message hereinafter for facilitating the description), the prefixes are put in the WR field and the length of the prefixes is put in the URL field. The identifier attribute is put in the PA field and the length (e.g., 4 octets) of the identifier attribute is put in the PAL field. In addition, the NLRI field may not be required.

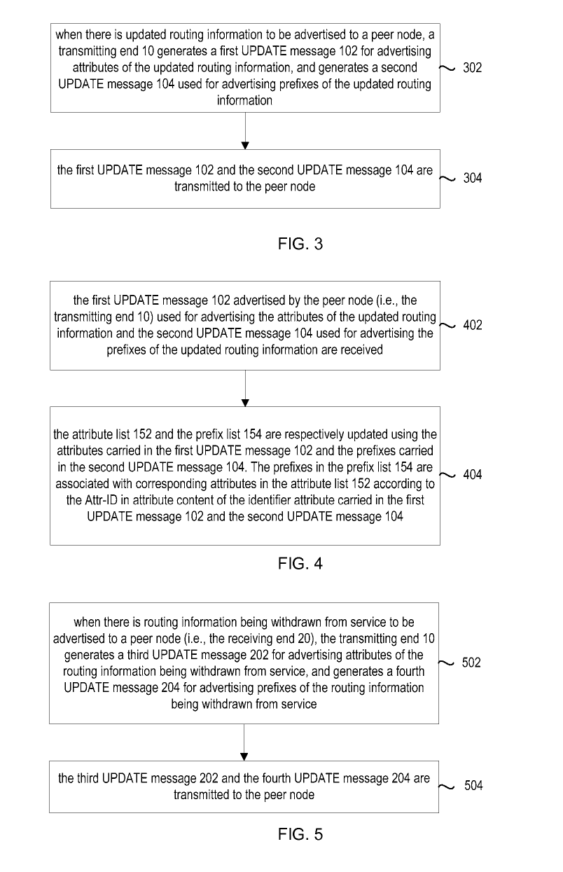

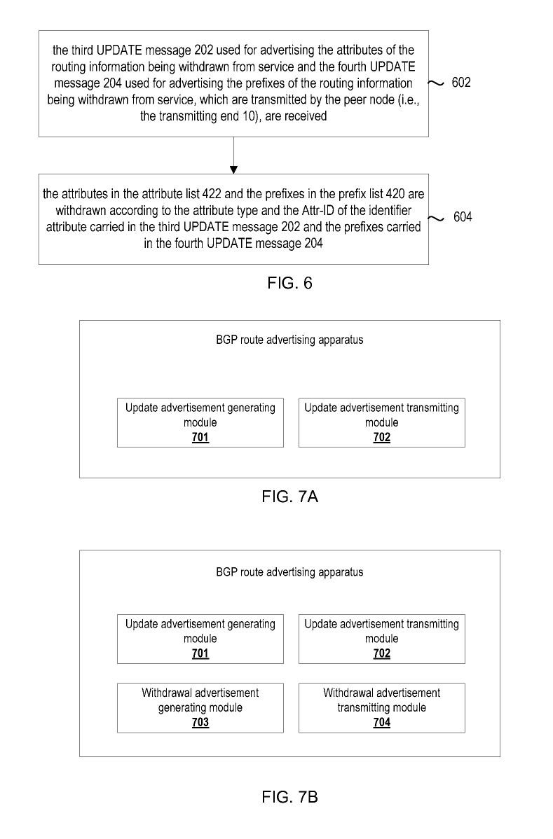

Hereinafter, examples are described with reference to accompanying drawings. FIG. 3 is a flowchart illustrating a method for advertising a BGP route at a transmitting end during a routing information update procedure according to an example of the present disclosure. FIG. 4 is a flowchart illustrating a method for advertising a BGP route at a receiving end during the routing information update procedure according to an example of the present disclosure. FIG. 5 is a flowchart illustrating a method for advertising a BGP route at a transmitting end during a routing information withdrawal procedure according to an example of the present disclosure. FIG. 6 is a flowchart illustrating a method for advertising a BGP route at a receiving end during the routing information withdrawal procedure according to an example of the present disclosure.

As shown in FIG. 1 and FIG. 3, the method for advertising a BGP route at the transmitting end during the routing information update procedure includes the following.

At block 302, when there is updated routing information to be advertised to a peer node (i.e., a receiving end 20), a transmitting end 10 generates a first UPDATE message 102 for advertising attributes of the updated routing information, and generates a second UPDATE message 104 used for advertising prefixes of the updated routing information.

In one example, the first UPDATE message 102 may carry the attributes of the updated routing information in the PA field 122. The second UPDATE message 104 may carry the prefixes of the updated routing information in the NLRI field 142. Both the first UPDATE message 102 and the second UPDATE message 104 carry an identifier attribute which identifies the attributes of the updated routing information by an Attr-ID in attribute content of the identifier attribute. The identifier attribute also indicates that the attributes are to be updated by a value, e.g., 0xff of an attribute type of the identifier attribute.

At block 304, the first UPDATE message 102 and the second UPDATE message 104 are transmitted to the peer node (i.e., the receiving end 20).

In block 304, the first UPDATE message 102 and the second UPDATE message 104 are transmitted to the peer node 20, such that the peer node 20 updates an attribute list 152 and a prefix list 154 using the attributes in the first UPDATE message 102 and the prefixes in the second UPDATE message 104, and associates the prefixes in the prefix list 154 with the corresponding attributes in the attribute list 152 according to the Attr-ID in the attribute content of the identifier attribute carried in the first UPDATE message 102 and the second UPDATE message 104.

As shown in FIG. 1 and FIG. 4, the method for maintaining a BGP route at the receiving end during the routing information update procedure includes the following.

At block 402, the first UPDATE message 102 advertised by the peer node (i.e., the transmitting end 10) used for advertising the attributes of the updated routing information and the second UPDATE message 104 used for advertising the prefixes of the updated routing information are received.

At block 404, the attribute list 152 and the prefix list 154 are respectively updated using the attributes carried in the first UPDATE message 102 and the prefixes carried in the second UPDATE message 104. The prefixes in the prefix list 154 are associated with corresponding attributes in the attribute list 152 according to the Attr-ID in attribute content of the identifier attribute carried in the first UPDATE message 102 and the second UPDATE message 104.

As shown in FIG. 2 and FIG. 5, the method for advertising a BGP route at the transmitting end 10 during a routing information withdrawal procedure includes the following.

At block 502, when there is routing information being withdrawn from service to be advertised to a peer node (i.e., the receiving end 20), the transmitting end 10 generates a third UPDATE message 202 for advertising attributes of the routing information being withdrawn from service, and generates a fourth UPDATE message 204 for advertising prefixes of the routing information being withdrawn from service.

In one example, the third UPDATE message 202 carries an identifier attribute in the PA field 154. The fourth UPDATE message 204 carries the prefixes of the routing information being withdrawn from service in the WR field 242. In another example, the fourth UPDATE message 204 may further carry the identifier attribute in the PA field 244. The identifier attribute identifies the attributes of the routing information using an Attr-ID identifier in the attribute content. The identifier attribute may further identify that the attributes are to be withdrawn using a value, e.g., 0xfe of the attribute type of the identifier attribute.

At block 504, the third UPDATE message 202 and the fourth UPDATE message 204 are transmitted to the peer node (i.e., the receiving end 20).

In block 504, the third UPDATE message 202 and the fourth UPDATE message 204 are transmitted to the peer node 20, such that the peer node 20 respectively withdraws corresponding attributes in an attribute list 422 and prefixes in a prefix list 420 according to the attribute type and the Attr-ID in the identifier attribute carried by the third UPDATE message 202 and the prefixes carried in the fourth UPDATE message 204.

As shown in FIG. 2 and FIG. 6, a method for maintaining a BGP route at the receiving end 20 during the routing information withdrawal procedure according to an example of the present disclosure includes the following.

At block 602, the third UPDATE message 202 used for advertising the attributes of the routing information being withdrawn from service and the fourth UPDATE message 204 used for advertising the prefixes of the routing information being withdrawn from service, which are transmitted by the peer node (i.e., the transmitting end 10), are received.

At block 604, the attributes in the attribute list 422 and the prefixes in the prefix list 420 are withdrawn according to the attribute type and the Attr-ID of the identifier attribute carried in the third UPDATE message 202 and the prefixes carried in the fourth UPDATE message 204.

In a practical application, the transmitting end 10 and the receiving end 20 may negotiate a transmission order of the first UPDATE message 102 and the second UPDATE message 104, and a transmission order of the third UPDATE message 202 and the fourth UPDATE message 204. Thus, the routing maintenance at the receiving end 20 may be simplified.

For example, during the routing information update procedure, the transmitting end 10 may transmit the first UPDATE message 102 prior to the second UPDATE message 104 which corresponds to the same routing information with the first UPDATE message 102, i.e., the attributes are advertised prior to the prefixes. During the routing information withdrawal procedure, the transmitting end 10 may transmit the fourth UPDATE message 204 prior to the third UPDATE message 202 which corresponds to the same routing information with the fourth UPDATE message 204, i.e., the prefixes are withdrawn prior to the attributes.

Accordingly, the receiving end 20 may operate according to the above order, i.e., a prefix is to be stored together with the attributes but does not exist by itself. For cases that a prefix exists by itself, it is determined that an error has occurred.

Before updating the prefix list according to the prefixes carried in the second UPDATE message 104 in block 404, the receiving end 20 determines, according to the Attr-ID in the identifier attribute carried in the second UPDATE message 104, whether attributes corresponding to the prefixes in the second UPDATE message 104 exist in the attribute list 152.

If such attributes exist, the prefix list is updated according to the prefixes in the second UPDATE message 104.

Otherwise, it is determined that an error has occurred and an error handling processing is performed by discarding the prefixes in the second UPDATE message 104.

The receiving end 20 may implement the withdrawal of the attributes and the prefixes by cancelling the attributes and the prefixes. During the withdrawal of the attributes maintained in the attribute list 422 according to the third UPDATE message 202, the receiving end 20 may determine whether corresponding prefixes exist in the prefix list 420 according to the Attr-ID in the identifier attribute carried in the fourth UPDATE message 204.

If exist, it is determined that an error is generated, an error handling processing may be performed by deleting all corresponding prefixes in the prefix list 420.

Otherwise, the attributes in the attribute list 422 are withdrawn.

The transmission order of the first UPDATE message 102 and the second UPDATE message 104, and the transmission order of the third UPDATE message 202 and the fourth UPDATE message 204 may also not be defined. The transmitting end 10 may transmit the first UPDATE message 102 and the second UPDATE message 104 which correspond to the same routing information by a random order in block 304. The transmitting end 10 may also transmit the third UPDATE message 202 and the fourth UPDATE message 204 which correspond to the same routing information by a random order in block 504.

At this time, the receiving end 20 is to allow existence of a single prefix without corresponding attributes or single attributes without a corresponding prefix. A single prefix which has no associated attributes or single attributes which have no associated prefix is configured as invalid. When both a prefix and its attributes exist and they correspond to the same Attr-ID, the prefix and the attributes are valid and associated with each other. In the receiving end 20, the attributes maintained in the attribute list and each prefix maintained in the prefix list have validity identifiers.

If certain attributes maintained in the attribute list 422 does not have a corresponding prefix in the prefix list 420, the validity identifier of these attributes is configured as invalid by the receiving end in block 404 or 604.

If a certain prefix maintained in the prefix list 420 does not have corresponding attributes in the attribute list 422, the validity identifier of this prefix is configured as invalid by the receiving end in block 404 or 604.

If both a prefix and its attributes which corresponds to each other exist, validity identifiers of the prefix and the attributes are configured as valid and are associated with each other at the receiving end in block 404.

In addition, for cases that use negotiation, the method for advertising the BGP route according to an example of the present disclosure may further include the following.

It is determined whether the peer node (i.e., the receiving end 20) supports attribute separate advertising through exchanging OPEN messages with the peer node (i.e., the receiving end 20) to perform a capability negotiation.

The OPEN message transmitted by the transmitting end carries an Attr-Adv Cap identifier. If the OPEN message returned by the peer node (i.e., the receiving end 20) carries the Attr-Adv Cap identifier, it indicates that the peer node (receiving end 20) has the Attr-Adv feature and supports attribute separate advertising. Otherwise, it indicates that the peer node (i.e., the receiving end 20) does not have the Attr-Adv feature and does not support attribute separate advertising.

The above blocks 302, 304, 502 and 504 are performed at the transmitting end after determining that the peer node (i.e., the receiving end 20) supports attribute separate advertising.

For cases that use negotiation, the method for maintaining the BGP route according to an example of the present disclosure further includes the following at the receiving end 20.

The receiving end 20 performs a capability negotiation with the peer node (i.e., the transmitting end 10) through exchanging OPEN messages with the peer node (i.e., the transmitting end 10) to notify the peer node (i.e., the transmitting end 10) whether the receiving end 20 supports attribute separate advertising. The OPEN message received by the receiving end 20 from the peer node (i.e., the transmitting end 10) includes the Attr-Adv Cap identifier. If the OPEN message returned by the receiving end 20 to the peer node carries the Attr-Adv Cap identifier, it indicates that the receiving end 20 has the Attr-Adv feature and supports attribute separate advertising.

The above blocks 402, 404, 602 and 604 are performed at the receiving end 20 after notifying the peer node (i.e., the transmitting end 10) that the receiving end 20 supports attribute separate advertising.

It should be noted that, for the receiving end 20, if it is detected the peer node acting as the transmitting end 10 is disconnected, the receiving end 20 may determine whether a graceful restart (GR) is successfully negotiated between the receiving end 20 and the transmitting end 10 instead of immediately deleting all information of the peer node.

If GR is successfully negotiated between the receiving end 20 and the transmitting end 10, a stale identifier is configured for all attributes corresponding to the peer node (i.e., the transmitting end 10) in the attribute list and all prefixes corresponding to the peer node in the prefix list. After receiving a subsequent first UPDATE message 102 and a subsequent second UPDATE message 104 from the peer node (i.e., the transmitting end 10), the receiving end 20 deletes the stale identifiers of the attributes corresponding to the peer node in the attribute list and the stale identifiers of the prefixes corresponding to the peer node in the prefix list.

Otherwise, the attributes corresponding to the peer node in the attribute list and the prefixes corresponding to the peer node in the prefix list are deleted.

An example of the present disclosure provides a BGP route advertising apparatus and a BGP route maintaining apparatus.

According to an example, the BGP route advertising apparatus may be applied to the transmitting end, as shown in FIG. 7A. The BGP route advertising apparatus includes: an update advertisement generating module 701, and an update advertisement transmitting module 702.

The update advertisement generating module 701 generates, when there is updated routing information to be advertised to a peer node (i.e., a receiving end), a first UPDATE message for advertising attributes of the updated routing information and a second UPDATE message for advertising prefixes of the updated routing information.

The first UPDATE message carries attributes of the routing information in a PA field, and the second UPDATE message carries prefixes of the routing information in a NLRI field; the PA field of both the first UPDATE message and the second UPDATE message carries an identifier attribute which identifies the attributes of the routing information by an Attr-ID in attribute content. In addition, the identifier attribute may further identify that the attributes is to be updated by a value, e.g., 0xff of an attribute type.

The update advertisement transmitting module 702 transmits the first UPDATE message and the second UPDATE message to the peer node (i.e., the receiving end).

According to another example, the BGP route advertising apparatus may further include a withdrawal advertisement generating module 703 and a withdrawal advertisement transmitting module 704, as shown in FIG. 7B.

The withdrawal advertisement generating module 703 generates, when there is routing information being withdrawn from service to be advertised to the peer node (i.e., the receiving end), a third UPDATE message for advertising attributes of the routing information being withdrawn from service and a fourth UPDATE message for advertising prefixes of the routing information being withdrawn from service.

The third UPDATE message carries an identifier attribute in a PA field. The fourth UPDATE message may also carry the identifier attribute in the PA field. The identifier attribute identifies the attributes of the routing information by the Attr-ID in the attribute content. The identifier attribute may further indicate that the attributes is to be withdrawn by a value, e.g. 0xfe of the attribute type of the identifier attribute.

The withdrawal advertisement transmitting module 704 transmits the third UPDATE message and the fourth UPDATE message to the peer node.

In a practical application, the first UPDATE message is transmitted prior to the second UPDATE message which corresponds to the same routing information with the first UPDATE message. The fourth UPDATE message is transmitted prior to the third UPDATE message which corresponds to the same routing information with the fourth UPDATE message. In another example the first UPDATE message and the second UPDATE message which correspond to the same routing information may also be transmitted in a random order. The third UPDATE message and the fourth UPDATE message which correspond to the same routing information may be transmitted in a random order.

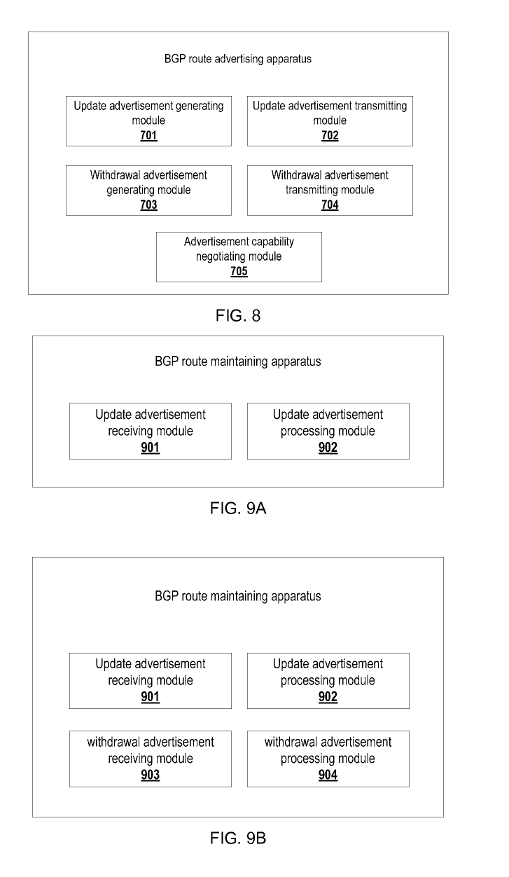

In addition, as shown in FIG. 8, for cases that use negotiation, the BGP route advertising apparatus may further include: an advertisement capability negotiating module 705.

The advertisement capability negotiating module 705 performs a capability negotiation with the peer node (i.e., the receiving end) through exchanging OPEN messages with the peer node (i.e., the receiving end) so as to determine whether the peer node (i.e., the receiving end) supports attribute separate advertising.

The OPEN message transmitted by the BGP route advertising apparatus carries an Attr-Adv Cap identifier. If the OPEN message returned by the peer node (i.e., the receiving end) carries the Attr-Adv Cap identifier, it indicates that the peer node (i.e., the receiving end) has the Attr-Adv feature and supports attribute separate advertising. Otherwise, it indicates that the peer node (i.e., the receiving end) does not have the Attr-Adv feature and does not support attribute separate advertising.

Operations of the update advertisement generating module 701, the update advertisement transmitting module 702, the withdrawal advertisement generating module 703, and the withdrawal advertisement transmitting module 704 are triggered after the advertisement capability negotiating module 705 determines that the peer node (i.e., the receiving end) supports attribute separate advertising.

According to an example, a BGP route maintaining apparatus may be applied to a receiving end, as shown in FIG. 9A. The BGP route maintaining apparatus includes: an update advertisement receiving module 901, and an update advertisement processing module 902.

The update advertisement receiving module 901 receives a first UPDATE message for advertising attributes of updated routing information and a second UPDATE message for advertising prefixes of the updated routing information which are transmitted by a peer node (i.e., a transmitting end).

The first UPDATE message carries attributes of the routing information in a PA field. The second UPDATE message carries prefixes of the routing information in a NLRI field. Both the first UPDATE message and the second UPDATE message carry an identifier attribute in their PA fields. The identifier attribute identifies the attributes of the routing information by an Attr-ID in attribute content. The identifier attribute may further indicate that the attributes are to be updated by a value, e.g., 0xff of an attribute type.

The update advertisement processing module 902 updates an attribute list and a prefix list respectively according to the attributes carried in the first UPDATE message and the prefixes carried in the second UPDATE message, and associates the prefixes in the prefix list with the corresponding attributes in the attribute list according to the Attr-ID in the attribute content of the identifier attribute carried in the first UPDATE message and the second UPDATE message.

According to another example, the BGP route maintaining apparatus may further include a withdrawal advertisement receiving module 903 and a withdrawal advertisement processing module 904, as shown in FIG. 9B.

The withdrawal advertisement receiving module 903 receives a third UPDATE message for advertising attributes of routing information being withdrawn from service and a fourth UPDATE message for advertising prefixes of the routing information being withdrawn from service which are transmitted by the peer node (i.e., the transmitting end).

The third UPDATE message carries an identifier attribute in the PA field. The fourth UPDATE may also carry the identifier attribute in the PAfield. The identifier attribute identifies the attributes of the routing information by an Attr-ID in the attribute content. The identifier attribute may further indicate that the attributes are to be withdrawn by a value, e.g., 0xfe of the attribute type of the identifier attribute.

The withdrawal advertisement processing module 904 performs a withdrawal operation to the corresponding attributes in the attribute list and the corresponding prefixes in the prefix list according to the value of the attribute type and the Attr-ID in the identifier attribute carried in the third UPDATE message and the prefixes carried in the fourth UPDATE message.

In a practical application, the first UPDATE message is transmitted prior to the second UPDATE message which corresponds to the same routing information with the first UPDATE message. The fourth UPDATE message is transmitted prior to the third UPDATE message which corresponds to the same routing information with the fourth UPDATE message. Alternatively, the first UPDATE message and the second UPDATE message which correspond to the same routing information may also be transmitted in a random order. The third UPDATE message and the fourth UPDATE message which correspond to the same routing information may be transmitted in a random order.

For the case that there is a transmission order,
before updating the prefix list according to the prefixes in the second UPDATE message, the update advertisement processing module 902 determines whether there are attributes corresponding to the prefixes in the second UPDATE message in the attribute list according to the Attr-ID in the identifier attribute carried in the second UPDATE message.
If so, the prefix list is updated according to the prefixes in the second UPDATE message.
Otherwise an error handling processing is performed by discarding the prefixes in the second UPDATE message.

The withdrawal advertisement processing module 904 performs the withdrawal operation to the attributes and the prefixes by cancellation. When performing the withdrawal operation to the attributes in the attribute list according to the fourth UPDATE message, the withdrawal advertisement processing module 904 further determines whether there is a corresponding prefix in the prefix list according to the Attr-ID in the identifier attribute carried in the fourth UPDATE message.
If so, an error handling processing is performed by deleting all corresponding prefixes in the prefix list.
Otherwise a withdrawal operation is performed to the corresponding attributes in the attribute list.

For the case that there is no transmission order,
the attributes maintained in the attribute list by the receiving end, and the prefixes maintained in the prefix list by the receiving end respectively has a validity identifier.
If the attributes maintained in the attribute list does not have a corresponding prefix in the prefix list, the update advertisement processing module 902 or the withdrawal advertisement processing module 904 configures the validity identifier of the attributes as invalid.
If the prefix maintained in the prefix list does not have corresponding attributes in the attribute list, the update advertisement processing module 902 or the withdrawal advertisement processing module 904 configures the validity identifier of the prefix as invalid.

When both a prefix and its attributes which correspond to each other (i.e., correspond to the same Attr-ID) exist, the validity identifiers of both the prefix and the attributes are configured as valid and are associated with each other by the update advertisement processing module.

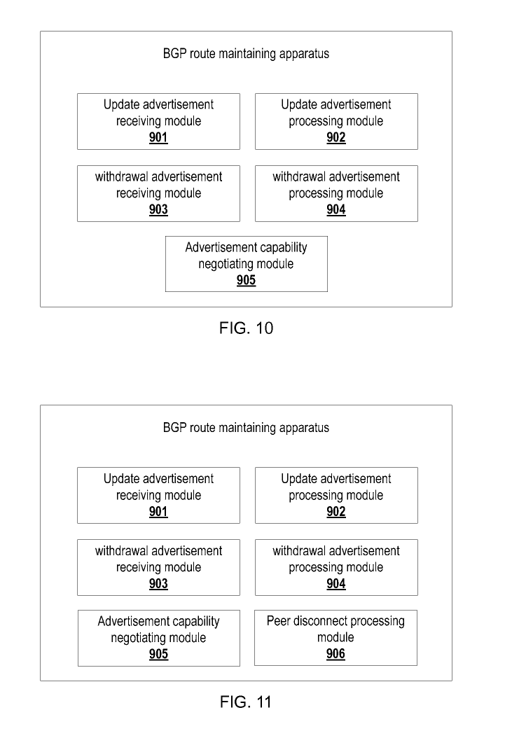

In addition, as shown in FIG. 10, for cases that use negotiation, the BPG route maintaining apparatus further includes: an advertisement capability negotiating module 905.

The advertisement capability negotiating module 905 performs a capability negotiation with the peer node (i.e., the transmitting end) through exchanging OPEN messages with the peer node (i.e., the transmitting end) so as to notify the peer node (i.e., the transmitting end) whether the BGP route maintaining apparatus supports attribute separate advertising. The OPEN message received by the BGP route maintaining apparatus from the peer node (i.e., the transmitting end) carries an Attr-Adv Cap identifier. If the OPEN message returned by the BGP route maintaining apparatus to the peer node carries an Attr-Adv Cap identifier, it indicates that the BPG route maintaining apparatus has the Attr-Adv feature and supports attribute separate advertising.

Operations of the update advertisement receiving module 901, the update advertisement processing module 902, the withdrawal advertisement receiving module 903 and the withdrawal advertisement processing module 904 are triggered after the advertisement capability negotiating module 905 notifies the peer node (i.e., the transmitting end) that the BGP route maintaining apparatus supports attribute separate advertising.

In addition, as shown in FIG. 11, for cases that the peer node is disconnected, the BGP route maintaining apparatus further includes a peer disconnect processing module 906.

The peer disconnect processing module 906 determines whether a GR is successfully negotiated between the BGP route maintaining apparatus and the peer node when detecting that the peer node is disconnected.
If so, a stale identifier is configured for all prefixes corresponding to the peer node in the prefix list and all attributes corresponding to the peer node in the attribute list. After a subsequent first UPDATE message and a subsequent second UPDATE message are received from the peer node, the stale identifiers of the attributes corresponding to the peer node in the attribute list and the prefixes corresponding to the peer node in the prefix list are deleted.
Otherwise the attributes corresponding to the peer node in the attribute list and the prefixes corresponding to the peer node in the prefix list are deleted.

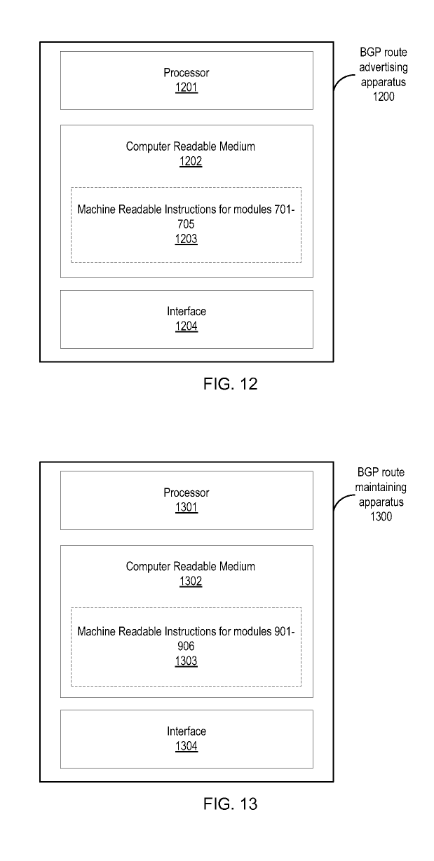

The above modules may be implemented by software (e.g. machine readable instructions stored in a non-transitory computer readable medium, such as memory, and executable by a processor), hardware (e.g. the processor of an ASIC), or a combination thereof. FIG. 12 shows hardware that may be in the BGP route advertising apparatus 1200. The modules 701-705 may be implemented with machine readable instructions 1203 stored in a non-transitory computer readable medium 1202 that are executable by the processor 1201 to perform the functions of the modules 701-705. An interface 1204 may include ports or other interfaces connected to a communication channel. FIG. 13 shows hardware that may be in the BGP route maintaining apparatus 1300. The modules 901-906 may be implemented with machine readable instructions 1303 stored in a non-transitory computer readable medium 1302 that are executable by the processor 1301 to perform the functions of the modules 901-906. An interface 1304 may include ports or other interfaces connected to a communication channel.

The above examples may be implemented by hardware, software, firmware, or a combination thereof. For example the various methods, processes and functional modules described herein may be implemented by a processor (the term processor is to be interpreted broadly to include a CPU, processing module, ASIC, logic module, or programmable gate array, etc.). The processes, methods, and functional modules may all be performed by a single processor or split between several processors. Reference in this disclosure or the claims to a “processor” should thus be interpreted to mean “one or more processors”. The processes, methods, and functional modules are implemented as machine readable instructions executable by one or more processors, hardware logic circuitry of the one or more processors, or a combination thereof. Further, the examples disclosed herein may be implemented in the form of a computer software product. The computer software product is stored in a non-transitory storage medium and includes a plurality of instructions for making a computer device (which may be a personal computer, a server or a network device, such as a router, switch, access point, etc.) implement the method recited in the examples of the present disclosure.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

1. A method for advertising a border gateway protocol (BGP) route, comprising:
when there is updated routing information to be advertised to a peer node, generating, by a BGP node, a first UPDATE message for advertising attributes of the updated routing information and a second UPDATE message for advertising prefixes of the updated routing information;
wherein the first UPDATE message carries the attributes of the updated routing information, the second UPDATE message carries the prefixes of the updated routing information, both the first UPDATE message and the second UPDATE message carry an identifier attribute for identifying the attributes of the updated routing information; and
transmitting, by the BGP node, the first UPDATE message and the second UPDATE message to the peer node.

2. The method of claim 1, further comprising:
when there is routing information being withdrawn from service to be advertised to the peer node, generating, by the BGP node, a third UPDATE message for advertising attributes of the routing information being withdrawn from service and a fourth UPDATE message for advertising prefixes of the routing information being withdrawn from service;
wherein the third UPDATE message carries an identifier attribute for identifying the attributes of the routing information being withdrawn from service, and the fourth UPDATE message carries the prefixes of the routing information being withdrawn from service; and
transmitting, by the BGP node, the third UPDATE message and the fourth UPDATE message to the peer node.

3. The method of claim 2, further comprising:
before generating the first UPDATE message and the second UPDATE message, or before generating the third UPDATE message and the fourth UPDATE message, performing, by the BGP node, a capability negotiation with the peer node through exchanging OPEN messages with the peer node to determine whether the peer node supports attribute separate advertising; and if the peer node supports attribute separate advertising, performing the process of generating the first UPDATE message and the second UPDATE message, or performing the process of generating the third UPDATE message and the fourth UPDATE message.

4. The method of claim 3, wherein the performing the capability negotiation with the peer node through exchanging OPEN message to determine whether the peer node supports attribute separate advertising comprises:
transmitting, by the BGP node, an OPEN message carrying a capability identifier indicating an attribute separate advertising capability to the peer node;
receiving, by the BGP node, an OPEN message returned by the peer node, the peer node supporting attribute separate advertising when the OPEN message returned by the peer node carries the capability identifier indicating the attribute separate advertising capability.

5. A method for maintaining a border gateway protocol (BGP) route, comprising:
receiving, by a BGP node, a first UPDATE message for advertising attributes of updated routing information and a second UPDATE message for advertising prefixes of the updated routing information which are transmitted by a peer node;
wherein the first UPDATE message carries the attributes of the updated routing information, the second UPDATE message carries the prefixes of the updated routing information, both the first UPDATE message and the second UPDATE message carry an identifier attribute for identifying the attributes of the updated routing information;
updating, by the BGP node, an attribute list and a prefix list respectively according to the attributes of the updated routing information carried in the first UPDATE message and the prefixes of the updated routing information carried in the second UPDATE message, and associating, by the BGP node, the prefixes of the updated routing information in the prefix list with the attributes of the updated routing information in the attribute list according to the identifier attribute carried in the first UPDATE message and the second UPDATE message.

6. The method of claim 5, further comprising:
receiving, by the BGP node, a third UPDATE message used for advertising attributes of routing information being withdrawn from service and a fourth UPDATE message used for advertising prefixes of the routing information being withdrawn from service which are transmitted by the peer node;
wherein the third UPDATE message carries an identifier attribute for identifying the attributes of the routing information being withdrawn from service, the fourth UPDATE message carries the prefixes of the routing information being withdrawn from service;
performing, by the BGP node, a withdrawal operation to corresponding attributes in the attribute list and corresponding prefixes in the prefix list according to the identifier attribute carried in the third UPDATE message and the prefixes of the routing information being withdrawn from service carried in the fourth UPDATE message.

7. The method of claim 6, further comprising:
before receiving the first UPDATE message and the second UPDATE message, or before receiving the third UPDATE message and the fourth UPDATE message, performing, by the BGP node, a capability negotiation through exchanging OPEN messages with the peer node to notify the peer node whether the BGP node supports attribute separate advertising, wherein when the BGP node supports attribute separate advertising, performing the process of receiving the first UPDATE message and the second UPDATE message, or performing the process of receiving the third UPDATE message and the fourth UPDATE message.

8. The method of claim 7, wherein the performing the capability negotiation through exchanging OPEN messages with the peer node to notify the peer node whether the BGP node supports attribute separate advertising comprises:
receiving, by the BGP node, from the peer node an OPEN message carrying a capability identifier indicating an attribute separate advertising capability;
returning, by the BGP node, an OPEN message carrying a capability identifier indicating the attribute separate advertising capability to notifying the peer node that the peer node supports attribute separate advertising.

9. The method of claim 6, further comprising:
determining, by the BGP node, whether a graceful restart (GR) is successfully negotiated between the BGP node and the peer node when detecting that the peer node is disconnected;
when a GR is successfully negotiated:
configuring stale identifiers for attributes corresponding to the peer node in the attribute list and prefixes corresponding to the peer node in the prefix list;
after receiving a subsequent first UPDATE message and subsequent second UPDATE message from the peer node, deleting the stale identifiers of the attributes corresponding to the peer node in the attribute list and the prefixes corresponding to the peer node in the prefix list;
when a GR has not been successfully negotiated, deleting the attributes corresponding to the peer node in the attribute list and the prefixes corresponding to the peer node in the prefix list.

10. A border gateway protocol (BGP) route advertising apparatus, comprising:
an update advertisement generating module to generate, when there is updated routing information to be advertised to a peer node, a first UPDATE message for advertising attributes of the updated routing information and a second UPDATE message for advertising prefixes of the updated routing information;
wherein the first UPDATE message carries the attributes of the updated routing information, and the second UPDATE message carries the prefixes of the updated routing information, both the first UPDATE message and the second UPDATE message carry an identifier attribute which identifies the attributes of the updated routing information;
an update advertisement transmitting module to transmit the first UPDATE message and the second UPDATE message to the peer node.

11. The BGP route advertisement apparatus of claim 10, further comprising:
a withdrawal advertisement generating module to generate, when there is routing information being withdrawn from service to be advertised to the peer node, a third UPDATE message for advertising attributes of the routing information being withdrawn from service and a fourth UPDATE message for advertising prefixes of the routing information being withdrawn from service;
wherein the third UPDATE message carries an identifier attribute identifying the attributes of the routing information being withdrawn from service, the fourth UPDATE message carries the prefixes of the routing information being withdrawn from service;
a withdrawal advertisement transmitting module to transmit the third UPDATE message and the fourth UPDATE message to the peer node.

12. The BGP route advertising apparatus of claim 11, further comprising:
an advertisement capability negotiating module to perform a capability negotiation through exchanging OPEN messages with the peer node to determine whether the peer node supports attribute separate advertising, wherein an OPEN message transmitted by the BGP route advertising apparatus carries a capability identifier indicating an attribute separate advertising capability, the peer node supports attribute separate advertising when an OPEN message returned by the peer node carries the capability identifier;
wherein operations of the update advertisement generating module, the update advertisement transmitting module, the withdrawal advertisement generating module, and the withdrawal advertisement transmitting module are triggered after the advertisement capability negotiating module determines that the peer node supports attribute separate advertising.

13. A border gateway protocol (BGP) route maintaining apparatus, comprising:
an update advertisement receiving module to receive a first UPDATE message for advertising attributes of updated routing information and a second UPDATE message for advertising prefixes of the updated routing information which are transmitted by a peer node;
wherein the first UPDATE message carries the attributes of the updated routing information, both the first UPDATE message and the second UPDATE message carry an identifier attribute which identifies the attributes of the updated routing information;
an update advertisement processing module to update an attribute list and a prefix list respectively according to the attributes of the updated routing information carried in the first UPDATE message and the prefixes of the updated routing information carried in the second UPDATE message, and associate the prefixes of the updated routing information in the prefix list with the corresponding attributes of the updated routing information in the attribute list according to the identifier attribute carried in the first UPDATE message and the second UPDATE message.

14. The BGP route maintaining apparatus of claim 13, further comprising:
a withdrawal advertisement receiving module to receive a third UPDATE message for advertising attributes of routing information being withdrawn from service and a fourth UPDATE message for advertising prefixes of the routing information being withdrawn from service which are transmitted by the peer node;
wherein the third UPDATE message carries an identifier attribute identifying the attributes of the routing information being withdrawn from service, the fourth UPDATE message carries the prefixes of the routing information being withdrawn from service;
a withdrawal advertisement processing module to perform a withdrawal operation to the corresponding attributes of the routing information being withdrawn from service in the attribute list and the corresponding prefixes of the routing information being withdrawn from service in the prefix list according to the identifier attribute carried in the third UPDATE message and the prefix carried in the fourth UPDATE message.

15. The BGP route maintaining apparatus of claim 14, further comprising:
an advertisement capability negotiating module to perform a capability negotiation through exchanging OPEN messages with the peer node to notify the peer node whether the BGP route maintaining apparatus supports attribute separate advertising, wherein an OPEN message received by the BGP route maintaining apparatus from the peer node carries a capability identifier indicating that the peer node supports attribute separate advertising, an OPEN message returned by the BGP route maintaining apparatus to the peer node carries the capability identifier to indicate that the BPG route maintaining apparatus supports attribute separate advertising;
wherein operations of the update advertisement receiving module, the update advertisement processing module, the withdrawal advertisement receiving module, and the withdrawal advertisement processing module are triggered after the advertisement capability negotiating module notifies the peer node that the BGP route maintaining apparatus supports attribute separate advertising.
